(19) United States
(12) Patent Application Publication
(10) Pub. No.: US 2006/0026285 A1
(43) Pub. Date: Feb. 2, 2006

(54) Systems and methods for transmitting electronic data

(76) Inventors: David Osofsky, Arlington, MA (US); David W. Nixon, Roswell, GA (US)

Correspondence Address: BROWN, RAYSMAN, MILLSTEIN, FELDER & STEINER LLP, 900 THIRD AVENUE, NEW YORK, NY, 10022, US

(21) Appl. No.: 11/191,332

(22) Filed: Jul. 28, 2005

Related U.S. Application Data
(60) Provisional application No. 60/591,729, filed on Jul. 28, 2004.

(51) Int. Cl. G06F 15/173

(52) U.S. Cl. 709/225

(57) ABSTRACT

Systems and methods for the transmission of electronic computer files are provided. One embodiment of the invention includes a framework of generalized components that allows a certain file, such as and email attachment, to properly operate on a recipient computer system regardless of whether the recipient computer includes a copy of the application program for which the attachment originated.

### CROSS-REFERENCE TO RELATED APPLICATIONS

The present application claims the benefit under 35 U.S.C. § 119(e) of U.S. Provisional Application Ser. No. 60/591,729 filed Jul. 28, 2004, the contents of which is hereby incorporated by reference in its entirety.

### COPYRIGHT AND LEGAL NOTICES

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright protection to the content disclosed herein.

### BACKGROUND OF THE INVENTION

The present invention relates generally to systems and methods for transmitting electronic data, and more particularly to systems and methods for transmitting data which may be received and operated on at a destination site without requiring the application program that created the data be present at the destination site.

In electronic messaging systems, it is often desired to attach additional files from other programs as part of, or in addition to, a message being sent. An example of such a message includes an email with an “attachment” such as a word document, a .pdf file, or a PowerPoint presentation. Such attachments often contain files created with a specific application program that are intended to be displayed or otherwise operated on by the recipient. Often, however, such attachments cannot be opened or displayed at the recipient's location because the software to find, generate and display such files only exists on the client from which the files originated (and is not present at the recipient location).

An example of such a situation may involve a Web Conferencing system that relies on complex infrastructure components such as screen scraping software and other complicated network protocols to properly run or display a certain application. Often, such systems merely share screen shots between conference participants. For example, assume that an HTML page for each slide in a PowerPoint presentation is created. When an application moderator moves to the next slide in the presentation, each participant is typically sent the URL to an HTML rendering, rather than a copy of the moderator's screen.

Thus, in order to generate high quality HTML renderings, the application that created the presentation (e.g. PowerPoint) must typically be used or referred to in some capacity (e.g., support files such as DLLs, scaling and conversion factors, etc.). The system serving these renderings, however, may not have the required application installed locally, (e.g. it may be a non-Windows server on which PowerPoint cannot be installed). Thus, in operation, the distributed renderings may be improperly displayed or may not be displayed at all without the associated support files. The appropriate support files, however, are resident on the system used to create the presentation. Thus, one possible solution to this problem is to have the user that created the presentation manually generate the correct renderings with all the correct parameters and send it to the server. However, this is time consuming and error prone and therefore undesirable.

It is also possible for a software developer to write a client software component that correctly performs rendering which may include writing code to search for, implement and coordinate operation of corresponding support files on a case-by-case basis (e.g., find the appropriate files, package them to be sent to the server, unpack them at the server, and recreate the directory structure at the server. etc.). However, this is also time consuming for the software developer and therefore undesirable.

Another solution involves rendering on the server using a conversion library. The drawback of this approach is that the quality of the rendering is usually poor. Despite the poor quality this is a popular solution because the development time of this solution is much smaller than a custom client side solution.

### SUMMARY OF THE INVENTION

Systems and methods for the transmission of electronic computer files are provided. One embodiment of the invention includes a framework of generalized components that allows a certain computer file, such as and email attachment, to properly operate on a recipient computer system regardless of whether the recipient computer includes a copy of the application program for which the attachment originated. In some embodiments, the computer files and any appropriate support files may be resident on a server computer system that passes pre-processed support information, such as graphics rendering information for proper display on an end-user computer system. In other embodiments, the support files may be fully or partially transmitted to an end-user computer system such that the computer files may be viewed with limited access to or substantially independently of the server computer system.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a block diagram of one embodiment of a system for transmitting electronic data constructed in accordance with the principles of the present invention.

FIG. 2 is a flow chart representing some of the steps involved in transmitting electronic data in accordance with one embodiment of the present invention.

### DETAILED DESCRIPTION OF THE INVENTION

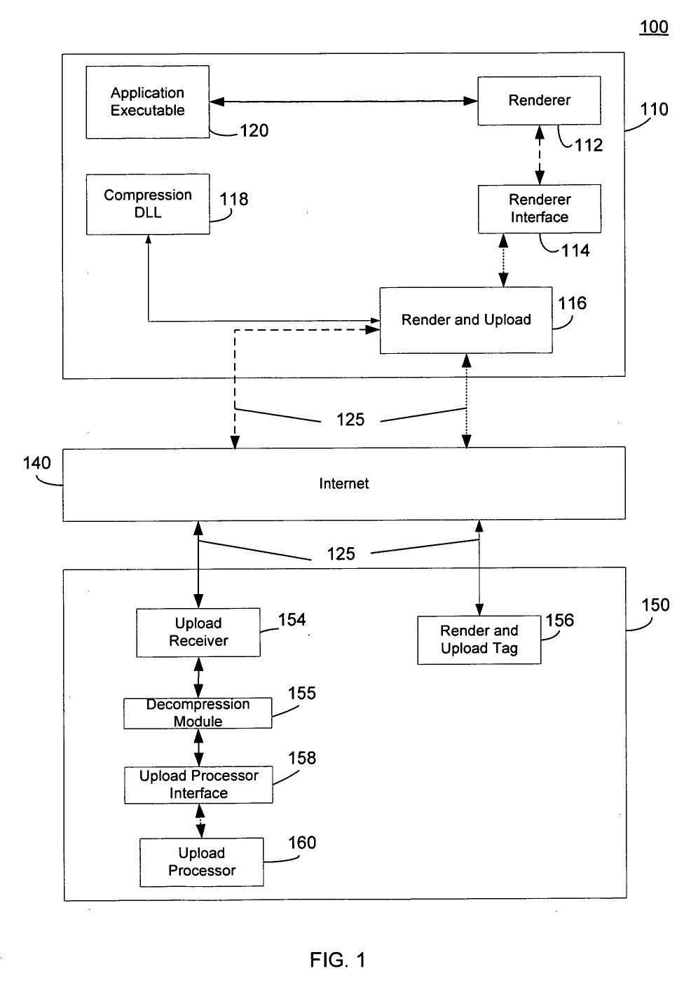

FIG. 1 is a block diagram of a messaging and file distribution system 100 constructed in accordance with the principles of the present invention. As shown, system 100 may include a client side component 110 and a server component 150. Generally speaking, for the purposed of illustrating aspects of the present invention, messages and other associated information such as attachments or other programs are generally conveyed from client 110 for distribution to others by or through server 150.

As shown, client component 110 may include a renderer 112, a renderer interface 114, a render and upload module 116, and a compression module 118. In some embodiments, render 112 may include a software algorithm which renders an image from an originating application program 120 (e.g., PowerPoint™, Word™, etc.) by calculating image color, size and proportions based on object visibility and lighting and shading models. These components may operate in conjunction with one another to generate an application file with the proper parameters for subsequent viewing (or otherwise properly operating) suitable for uploading to server 150.

As shown, server component 150 may include an upload receiver 154, a render and upload and tag module 156, and upload processor interface 158 and an upload processor 160. Server 150 and client 110 may be coupled together as shown through Internet 140 through connection paths 120.

Although depicted as a server in FIG. 1, server component 150 may be any type of remote computer, network, database or other repository suitable for storing and retrieving electronic content. Similarly, client component 110 may be any suitable computer, network, or other electronic processing unit capable of requesting, receiving, and/or manipulating data files or programs as further described herein. In some embodiments, client component 110 and/or server 150 may include proprietary or other specialized software and/or hardware for manipulating or modifying data or other electronic programs. Such software and/or hardware may be controlled or configured either fully or partially by an end user or a service or content provider.

Furthermore, although generally represented as Internet 140, this communication network may be any other suitable network desired any may include an Intranet, a wireless interconnection, LAN, WAN, or other interconnection such as a hardwired or wireless interconnection (generally depicted as additional communications links 125). Internet 140, server 150, and client 110 are shown only for the purpose of general illustration and not limitation. Moreover, it will be understood that although the present invention is well suited for the distribution of conferencing or presentation materials, any other suitable content may be distributed if desired (e.g., documents, spreadsheets, document management files etc.).

Generally speaking, system 100 of the present invention may operate as follows. A user (not shown) at client 110 may select a certain section of electronic content or a program stored on client 110 for uploading to server for subsequent transmission to others via web conference, email with an attachment or other means. This request may be routed to render and upload module 116 that may locate and retrieve the specified content or program, for example, using the base file name. Module 116 may also concurrently or subsequently find and call any specified client objects to generate the appropriate associated support files, which may include for example, DLLs. In some embodiments, this may involve placing a call through renderer interface 114 to invoke renderer 112, through which the application executable file 120 is obtained. In some embodiments, this render may be specific to the program that created the specified content. Module 116 may also, among other things, call compression module 118 to compress the retrieved files to facilitate transfer (e.g. create a “zip” or other compressed file). This may also involve ensuring the proper files are “present” in the file “package” to uploaded to server 150 including taking into account the appropriate directory structure needed to uncompress and properly run the transferred files.

In some embodiments, the generally above-described operation may include various additional actions. For example, renderer 112, may employ a software algorithm which renders an image based on the application program generating the images. Thus, in operation, render 112 may convert, scale or otherwise manipulate or process images or programs within or associated with executable 120 identified to be sent to server 150 such that the resulting images or graphics contain the proper display parameters (e.g., size, proportion, color etc.). This allows module 116 to call the application executable files 120 along with the appropriately modified support files for uploading to server 150 (described in more detail below). However, it will be understood that principles of the present invention may be employed for any type of file with or with without graphics. In non-graphical applications, render and upload module 116 may ensure that the proper support files are uploaded to server. Such files may include any DLL or files required to ensure compatibility or program execution.

In some embodiments, renderer 112 may be specific for each application program. In other embodiments, however, renderer 112 may be fully or partially generic (i.e., operate with one or more applications) and create or convert support files based on various factors such as content, desired audience, etc.

In some embodiments, different render 112 modules (not shown)may be chosen by renderer and upload 116 in response to different content type (e.g., using or based on a component object model). Interface 114 and/or builder render 112 may generate the appropriate support files by consulting or interoperating with the application program that generated executable 120. For example, in the case of a PowerPoint file, the may include making OLE Automation calls to the PowerPoint program.

In some embodiments, module 116 may employ elements of MicroSoft™ Active-X™, Netscape Plug-ins, Java applets or other suitable technology to facilitate the transfer of content. This may include, for example, an Active-X™ control which may retrieve file names from HTML file input fields, pass file names to a specified renderer, and coordinate compression and tracking of selected files. In operation, module 116 may post the HTML file names rather than specific content. If desired, Active-X™ may be extended to support file specification user interfaces other than HTML inputs fields, such as “drag and drop.”

In some embodiments, Active-X™ or other suitable technology may be installed on client 110, server 150 or a combination of the two. For example, in one embodiment, renderer and upload tag module 156 may supply markup for the Active-X™ control to module 116 along with a parameter for the names of any HTML or other file input fields (if not specified, all input fields may be identified). In such an embodiment, module 156 may also include parameters for the class ID for a certain renderer and the name of any upload receiver action (e.g., as may be specified in struts-config.xml) and the class name of the upload receiver 154 to receive any content from client 110. In alternate embodiments, some or all of these files may be present in client 110 and/or module 116.

After the files have been appropriately identified and arranged, they may be transmitted to server 150 via communication links 120 and Internet 140. These files may be received by upload and receiver component 154. Receiver component 154 may “unpack” the received files and arrange them in a directory structure the same as or similar to as they were arranged on client 110 prior to delivery to server 150. This typically may uncompressing any compressed files with decompression module 155 and creating the proper directory or other structure or links necessary for proper execution of the received files. In some embodiments, this may involve consulting a Struts™ action class in upload receiver component 154. The action class may be referenced by and packaged into portlets that utilize these programs. Thus, upload receiver component 154 may receive certain compressed (e.g., “zipped”) files from client 110, unzip these files and place them in a temporary directory on server 150 and then invoke upload processor 160 through upload processor interface 158 to process the received files (which may be based on parameters or and interface specified at the client or server end).

Upload processor 160 may then coordinate with upload receiver interface 153 (which may be a Java-based interface) to perform the proper post processing of the programs transferred from client 110. Generally speaking, this includes generating the proper support or interpretation files that may be used to allow message or attachment recipients to properly view any attachment or transferred files sent to third parties. Such post processing may involve the use of certain application specific programs generated or used by upload processor 160. More particularly, this may also include locating and placing a call to the proper “plug-in” programs at the server to handle the uploaded files created by a specific application. Such a “plug-in” may, for example, make the files available in a document repository or database.

In some embodiments, the support files may be maintained on server 150 such that the files transferred to an end user have already been properly preprocessed for display. However, in alternate embodiments, some or all of the support files may be transmitted to the end user location such that the transferred files or specific application generated programs may be run at the that location substantially independently of server 150 (e.g., other than the transfer of information relating to the location of certain files).

In some embodiments upload processor 160 may be implemented as classes in a servlet or portlet that are passed the name of the temporary directory which contains the unpacked files sent from client 110 created by render and upload module 116 and renderer 112. Moreover, as shown in FIG. 1, server 150 may generally include such items as Websphere™ Portal server portlet that contains some or all of the components resident on server 150. Moreover, in some embodiments, if desired, Active-X™ and processes associated with Active-X™ may be configured to enhance the security of system 100. For example, Active-X™ or other suitable management program may be configured not to execute downloaded files and may only render uploaded files from HTML input fields, etc.

Some embodiments of the present invention may be implemented as a generalized framework and programming model that can be used to implement a wide range of software applications including document management renderings, document management reference dependencies and lightweight meeting renderings. Such a framework, once implemented for a specific client and server environment may support this broad range of applications. For example, system 100 described above may be arranged into two basic component types: framework components and framework consumer components.

Generally speaking, framework components may implement the overall framework for a particular client and server system (i.e. application independent). Framework components may include render and upload component 116, upload receiver component 154, renderer interface 114, upload processor interface 158, decompression module 155, render and upload tag 156, and compression module 118. These components may collectively operate together to obtain, transmit and run the appropriate software on server 150 or third party client that allows an certain program to properly operate irrespective of whether the application that created that program is accessible at a particular location.

Framework consumer components, on the other hand, are generally components that are implemented by a particular application (e.g., PowerPoint™ or Word™). These may include renderer 112 and upload processor 160. These components may perform functions specific to a particular application, such as provide the proper scaling factors, data storage, algorithms or other processes to ensure the proper display of any files transmitted from client 110. In certain embodiments, framework components may provide the proper environment within which the framework consumer components operate.

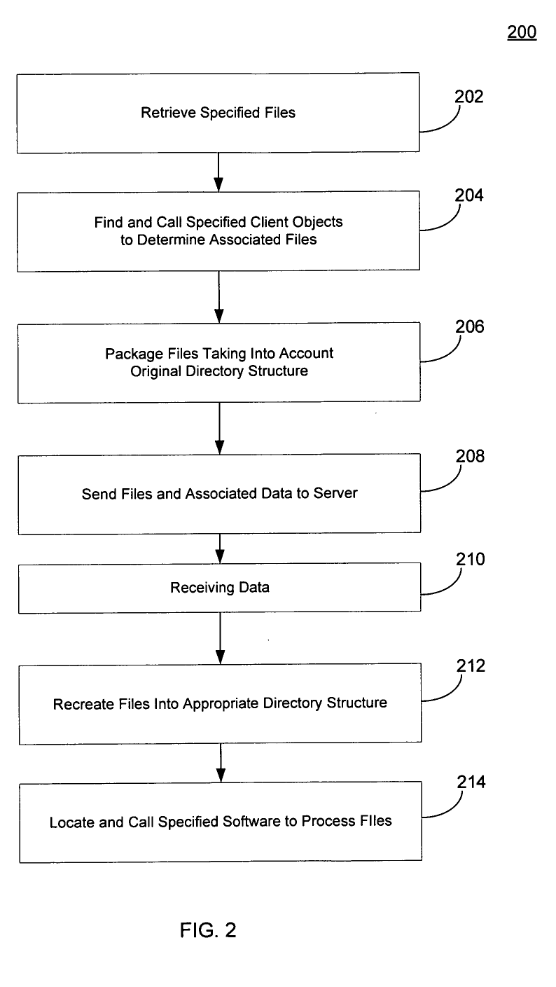

Some of the steps associated with transmitting electronic data in accordance with an embodiment of the present invention is shown in flowchart 200 of FIG. 2. As shown, at step 202, a user may locate or specify a certain file for transmission to others (e.g., as an attachment to an email). Next, at step 204, certain application files may be may be retrieved via a renderer such that the the renderer generates any necessary support files which may include the correct rendering of any graphics or images using the appropriate algorithms or scaling factors. This may also include locating any appropriate support files such as DLLs. In some embodiments, this processing (and the associated interface) may be specific to the application program that generated the file to be transferred (e.g., PowerPoint™). Moreover this step may also involve the use of a management component, such as Active-X™, to identify and specify any HTML tags or fields to be used in the upcoming file transfer.

Next at step 206, the retrieved files may be arranged and packaged for transfer to a server. This may involve retaining the files in a directory structure initially found on the client computer system and compressing the files to be transferred. Next, at step 208 the files may be transferred from an origination computer (e.g., a client computer) to a destination computer (e.g., a network or server computer) via a communication network. At step 210 the files may be received by an upload component at the destination computer. At step 212, the transferred files may be extracted (e.g., uncompressed) and recreated in a directory structure the same as or similar to that found on the origination computer. Next, at step 214, the files may be stored in a data or content repository or post processed such that they may be transmitted to other computers and viewed or executed properly. This may involve using a consumer component transmitted from the origination computer or pre-existing “plug-in” program capable of properly processing the received files.

Subsequently, the processed files may be communicated to third parties for viewing, which may include HTML page locators which are processed at the server computer and then provided to an end user. Or in other embodiments, the extracted files in the appropriate directory structure may be communicated to the end user, such that files may be processed by the end user rather than the server computer.

Although several steps in the fault detection and monitoring process have been described above, it will be understood that these steps are merely illustrative, and are not meant to be comprehensive or necessarily performed in the order shown.

Moreover, while the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A system for providing computer files based on an application program for viewing by an end-user comprising:
a client computer system for generating the computer files to be viewed by the end user, wherein the client computer system is configured to provide appropriate support files for viewing the computer files; and
a server computer system for receiving the computer files and the appropriate support files, wherein the server computer executes both the computer files and the support files such that the end user may properly view the provided computer files irrespective of whether or not the server computer system or a computer system of the end user include the application program.

2. The system of claim 1 wherein the client computer system further comprises a render and upload component that arranges the computer files for transmission to the server computer system.

3. The system of claim 2 wherein the render and upload component is configured to arrange the computer files for transfer to the server computer system in a directory structure substantially similar to a directory structure on the client computer system.

4. The system of claim 1 wherein the client computer system further comprises a compression component for compressing the computer files.

5. The system of claim 2 wherein the client computer system further comprises a renderer component that interoperates with the application program to obtain the computer files.

6. The system of claim 5, wherein the client computer system further comprises a renderer chosen by the render and upload component that generates rendering of the computer files.

7. The system of claim 1 wherein the server computer system further comprises an upload receiver to receive the computer files and appropriate support files transferred by the client computer system.

8. The system of claim 7 wherein the upload receiver is configured to uncompress the computer files and appropriate support files.

9. The system of claim 7 wherein the server computer system further comprises an upload processor chosen by the upload receiver.

10. The system of claim 9 wherein the upload processor processes and/or stores the computer files and appropriate support files such that the computer files may be properly displayed on the end user computer system.

11. A system for transmitting computer files based on an application program for viewing by an end-user comprising:
a client computer system form which the computer files originate; and
a server computer system that receives the computer files for transmission to end users; and a plurality of framework components disposed on the client and server computer systems that establishes a general environment that allows a software developer to create a system that allows an end user to properly view the transmitted computer files irrespective of whether or not the server computer system or a computer system of the end user include the application program.
